(19) United States
(12) Patent Application Publication
(10) Pub. No.: US 2005/0081588 A1
(43) Pub. Date: Apr. 21, 2005

(54) Apparatus and method for die inerting

(76) Inventors: Richard Twigg, Muskogee, OK (US); Robert Oesterreich, Sugar Land, TX (US)

Correspondence Address: AIR LIQUIDE, 2700 POST OAK BOULEVARD, SUITE 1800, HOUSTON, TX, 77056, US

(21) Appl. No.: 10/931,452

(22) Filed: Sep. 13, 2004

Related U.S. Application Data
(63) Continuation-in-part of application No. 10/306,322, filed on Nov. 27, 2002.

(51) Int. Cl. B29C 31/00

(52) U.S. Cl. 72/38

(57) ABSTRACT

An improved apparatus and method for metal extrusion applications and presses wherein high purity inert and/or partially inert gases are introduced at or near the die exit. The environment at or near the exit is also preferably analyzed and/or monitored on a continual or nearly continual basis. The environment is also preferably controlled to which minimize or eliminate oxidation of metals and other extruded materials. The apparatus and method allow faster extrusion rates, improved surface quality of the extruded materials, and increased die life. In an embodiment, bi-phasic inerting media may also be used.

### CROSS REFERENCE TO RELATED APPLICATION

This application claims the benefit of U.S. Non-Provisional Application No. 10/306,322, filed Nov. 27, 2002.

### FIELD OF INVENTION

This invention relates to an apparatus and method for improved extrusion applications. The improved extrusion process includes the feature of analyzing the environment or atmosphere and controlling the environment at or near the die exit.

### DESCRIPTION OF THE RELATED ART

In the process of extruding metals, metal alloys, and other oxidizing materials, it is known that the presence of oxygen causes an oxide layer to form in and around the die, backer, bolster, die exit, tunnel or platen, as well as the extruded product.

U.S. Pat. No. 5,894,751 is directed to a shroud canister for reducing the oxidation of extruded metal in an extrusion press by introducing an inert substance in liquid form into a die ring. In an embodiment the shroud canister consists of a face plate which is attached to the platen of the extrusion press, a fluid supply tube for injecting the inert substance into the bore of the platen, and a shield to preclude any of the substance which is in liquid form from leaving the supply tube and coming into contact with the extruded material. Another embodiment consists of a cylindrical canister with one or more apertures for the extruded metal and a relatively inert substance supply cavity that communicates with the supply to inject the substance into the product apertures. Kevlar strips may also be hung across the faceplate in order to cover the aperture in the faceplate to further retard the introduction of oxygen into the bore of the platen.

U.S. Pat. No. 3,808,865 is directed to a method and apparatus for extrusion of work pieces. The invention uses a cooling medium to transfer excessive heat from the apparatus, in order to increase extrusion speed. Therein, a deep cold liquefied inert gas is used the cooling medium to create a protective atmosphere at the downstream end of the apparatus to eliminate the oxidizing effects of normal air.

U.S. Pat. No. 4,578,973 is directed to a process for producing hollow aluminum extrudates for use in a high vacuum environment. The disclosed process concerns producing a hollow aluminum extrudate for use in a vacuum which comprises the steps of hermetically closing the forward open end of a hollow shaped material immediately after extrusion, cutting the material after a pre-determined length, and hermetically closing the cut end during extrusion so the inner surface of the hollow portion is out of contact with the atmosphere to thereby inhibit an oxide layer from forming. The process is also operated in a high vacuum environment. Therein, the mixture comprises approximately 0.5 to 30% by volume of oxygen, with the balance being an inert gas.

U.S. Pat. No. 5,133,126 is further directed to a method of producing an aluminum tube covered with zinc. Therein, the method of producing an aluminum tube that is covered by a layer of zinc is disclosed. Herein, the oxidation problem is solved with using flame sprayed zinc powder, and the method comprises the steps of providing a cold forming machine with an extrusion die assembly aluminum prime wire and extruding the wire while heating the die to about 450E to 550EC, blowing an inert gas across the die thereby providing a non-oxidized aluminum tube, then flame spraying zinc powder onto the outer non-oxidized surface of the tube thereby covering the surface an providing an anti-corrosive layer.

### BRIEF DESCRIPTION OF THE DRAWINGS

FIG. 1 shows an embodiment of an apparatus of the invention;

FIG. 2 is a schematic showing an embodiment of the apparatus and method;

FIG. 3 is a schematic showing an aspect of the invention;

FIG. 4 is an embodiment of the apparatus and method;

FIG. 5 is a component of the apparatus of the invention;

FIG. 6 is a component of the apparatus of the invention; and

FIG. 7 is a side view of embodiment of the invention.

### DESCRIPTION OF THE PREFERRED EMBODIMENTS

For purposes of the description of this invention, the terms “up,” “down,” “near,” “bottom,” and other related terms shall be defined as to relation of embodiments of the present invention as it is shown and illustrated in the accompanying figures. However, it is to be understood that the invention may assume various alternative structures and processes and still be within the scope and meaning of this disclosure. Further, it is to be understood that any specific dimensions and/or physical characteristics related to the embodiments disclosed herein are capable of modification and alteration while still remaining within the scope of the present invention and are, therefore, not intended to be limiting.

The properties and the surface of extruded materials and work pieces that are formed out of aluminum, metal, metal alloys, and especially metals which oxidize during the extrusion process are determined by a variety of factors, especially the billet or ingot temperature and the speed of extrusion. If a higher temperature is used during the extrusion process, there is less deformation work required by the press. However due to heat buildup, the aluminum or other metal almost becomes liquid, which typically causes the metal to oxidize. During typical operations where atmospheric oxygen may be present in relatively large concentrations, oxides collect at the downstream end of the working surface of the material or tool like a crust and the formation of these deposits are promoted with deformation heat in the working parts of the die exit area and/or extruded material.

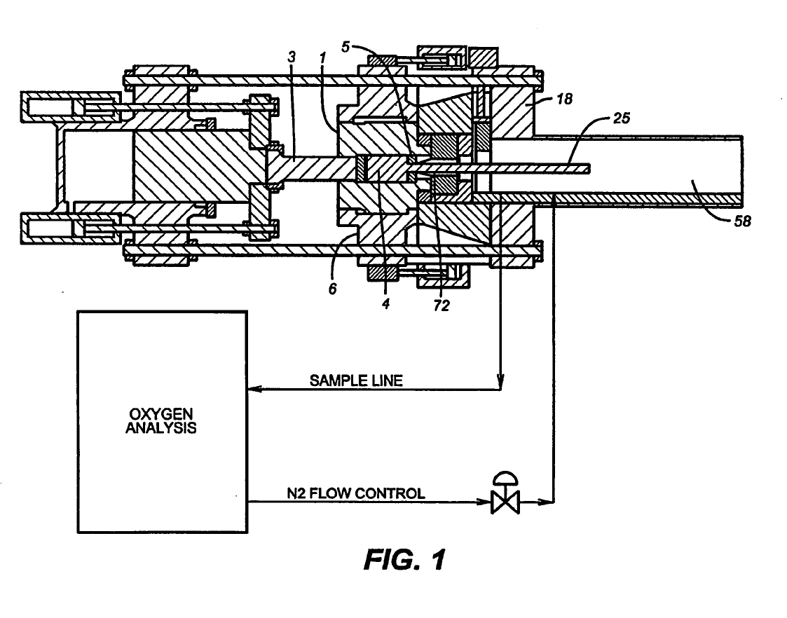

The invention utilizes high purity nitrogen or argon, in gaseous and/or in a bi-phasic form, i.e., gas and liquid, to purge the environment or atmosphere at or near the exit side of the die, and if applicable, also through the platen 18 or platen tunnel 58. Oxides, which normally appear on the surface of the extrudate, as well as the working parts of the die exit area are the main sources of surface imperfections and defects such as hot tears, die lines, and pinning, and other types of disintegration of the oxide layer that cannot be tolerated on products or extrudates which require smooth, ornate finishes. These oxide deposits also create local hot spots due to the friction between the abrasive oxide and the extrudate, and are extremely wear resistant. If unregulated and unmonitored oxide layer collects behind the die bearing and causes die pickup, during the prior art methods, using the prior art apparatuses. However, by inerting preferably all the critical areas of the extrusion press, e.g., tools or devices for storing, cutting or shaping, the die 5, backer 13, bolster 17, and flat metal plate, oxides are nearly or completely eliminated. See e.g. FIGS. 1-3. In fact an inerting atmosphere can be used to minimize the oxidation reaction or even eliminate the oxidation reaction and the undesirable oxide deposits.

When inert or partially inert gases are injected or otherwise introduced into the die area of an extrusion press or environment at or near the die exit, the inerting gas displaces the atmospheric air thereby significantly reducing the formation of oxides, since less oxygen is available to form oxides. By inerting the die exit and platen zones, the deposit reaction: Al+O₂=Al₂O₃ is controlled by minimizing oxygen which therefore limits the oxide production and reduces deposits. This design and process supplies an oxygen-depleted atmosphere at or near the die exit. Moreover, the use of high purity nitrogen or inerting gas improves productivity with an extrusion rate increase of up to or about 30%, the extruded metal or part has enhanced shaped integrity and an improved surface finish which appears bright and/or anodized, and also optimally requires less polishing and buffing. The inerting also ensures better surface shape integrity. The use of such inerting gases and/or bi-phasic mixtures has the added benefit of increasing the die run life about twofold, and the traditional post extrusion die cleaning is reduced or eliminated.

Alternatively, liquid and gas, a bi-phasic mixture, can be used with the liquid which depending on amount, may also offer some cooling properties. Moreover, the use of a bi-phasic or liquid-gas mixtures may be used to “purge” the exit area using the rapid expansion going from a liquid to a gas, due to the volume expansion of about a 700-800 fold. Because the die exit area is hot, some liquid is readily vaporized to gas. If the liquid does not all vaporize this can also lead to some undesired irregularities in the extruded materials and pieces.

In the preferred embodiment and process, nitrogen comprises the majority of the inerting gas or media since it is less expensive than helium and argon in applications using only gas, insulated lines and liquid. For simplicity sake such gases will be referred to as inerting gases, or inerting media if it is in a bi-phasic form. Preferably pure nitrogen is used for optimal results. However, the nitrogen used need not be pure, as long as it contains a low concentration of oxygen, such as about 1-3% or less, thus preferably resulting in an atmosphere near the die exit of about less than about 2%, and optimally about 1% or less. By using nitrogen, preferably containing about or less than 1% oxygen, the production of inferior or off-specification extrusions are eliminated. The invention also contemplates the use of multiple sources of the gas or inerting media with different flow rates, purity, pressure, and/or location near the exit, and the tunnel subcoolers of the prior art are also not necessary.

When choosing and using gaseous and/or liquid nitrogen or other inert or partially inert components during extrusion, especially for aluminum extrusion, several factors need to be considered, such as the maximum oxygen which can be tolerated while still achieving the desired surface quality. Inert gas requirements also vary depending on the alloy, shape, extrusion speeds, and gas flow rate and vary with the number and size of the presses and the number of billets, which are used. Therefore, it is also preferable to include an analyzer to monitor the oxygen content near the die exit. It is also preferable to use a controller, which can regulate the flow, pressure, and in some cases, the purity of the inerting gas used. The monitoring of the environment at or near the die exit coupled with the control of gas flow optimizes the use of such inert gas or inert media.

The extrudate, or if applicable work pieces, can be produced a variety of ways and by using a variety of dies known to one skilled in the art. There are solid, semi hollow, and hollow dies, and the shape of the die determines the shape of the extruded material or part. The extrusion dies may take on various forms, and may have a variety of features that are known to one skilled in the art.

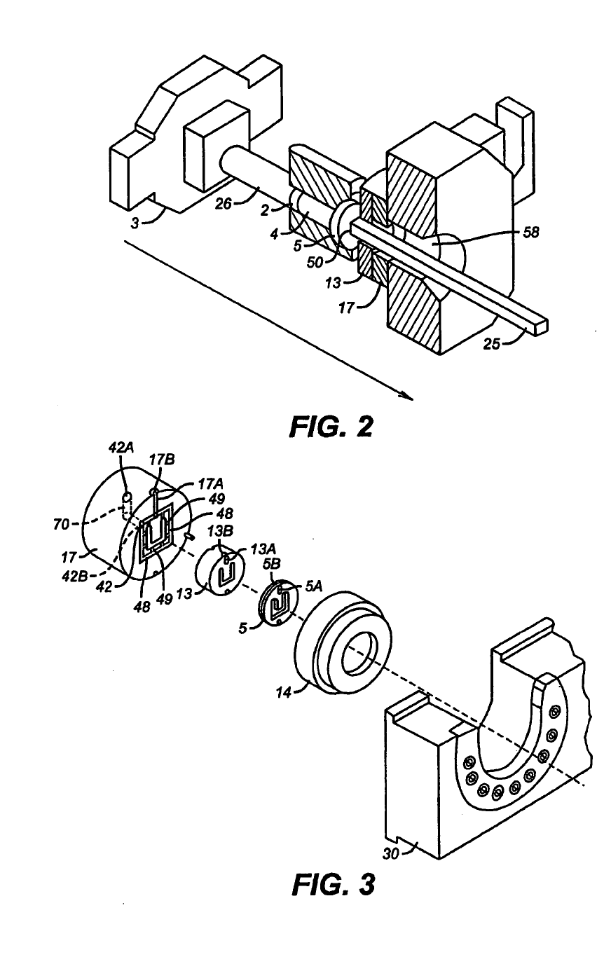

Typically before extrusion, the dies are cleaned with a caustic agent, and a billet 4 of metal or metal alloy is processed at the preferred temperature and time. The aluminum or other metal is heated usually either electrically through induction heaters or through the use of gas fired furnaces. While the temperature and speed of extrusion varies upon the application and metal used, the preferable temperature of the extrusion die is maintained within a range of 450° to 550° for aluminum applications. Once the metal has reached the desired or specified temperature, it is loaded into the container 1 of the extrusion press 6, an example of which is shown in FIGS. 1, 3 and a perspective cut-away view is shown in FIG. 2. The container 1 of the example press is a hollow chamber that is typically constructed of steel and is usually fitted with a liner 9 that is removable, e.g. see FIG. 3. The container 1 also has an inside diameter slightly larger than the billet 4 which is to be extruded, and holds and confines the billet 4 during the extrusion cycle.

Further down, there is a ram 3, stem 26, a dummy block 2, and a billet 4, a die 5, a die holder or die ring 14, and a bolster 17. See e.g., FIGS. 1-3. There may also be a backer 13 which backs up against the exit or die opening. See e.g., FIGS. 2-3. The die ring 14 and the backer 13 are typically attached to the die 5 to support the die 5 with the die ring 14, and the backer 13 is provided to prevent deformation of the die body 5 due to pressure experienced during the extrusion processes, and there may be a pressure ring 28 adjacent to the die slide 30.

The die 5 is a disk typically comprised of steel, and aluminum or other metal is forced through the opening(s) in the die or die exit 50 to create the extruded product. The pressure in an extrusion press 6 is applied by a hydraulic ram 3, which can use exert from about 100 tons to 15,000 tons or more of force. The amount of force which an extrusion press is able to exert determines the profiles that it is capable of producing. After the temperature of the die 5 is adjusted to a desired temperature by a heating device, for example a heater (not shown) mounted between the die 5 and the die ring 14, the metal or metal alloy material is extruded by the hydraulic ram 3 which applies pressure which crushes the billet 4 up against the die, forcing it into contact with the container wall. Once the heated metal is contacted, the pressure increases and the heated metal is pushed through the die opening or exit 50 and emerges at the exit as a shaped profile., e.g., 25.

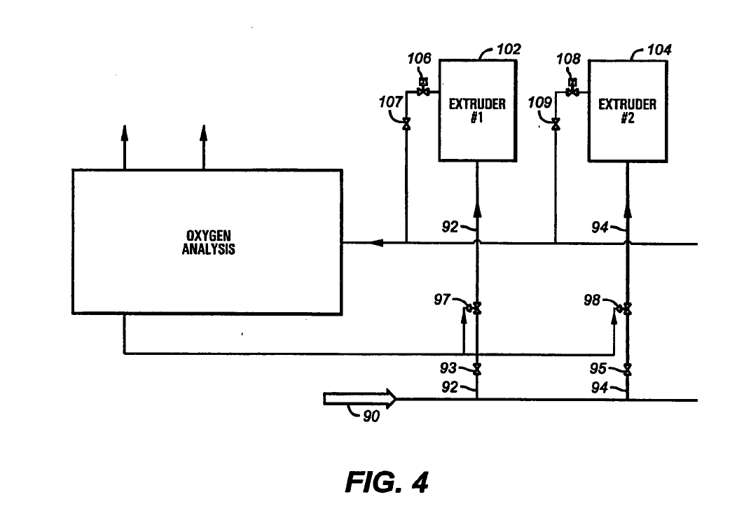

The apparatus will also further comprise a supply 90, see e.g. FIG. 4, of inert or partially inert gas and/or bi-phasic inerting media that is connected to, near, or at the die exit, typically by lines, and the gas or inerting media may be stored in a standard bulk installation tank with a vaporizer or heat exchanger, or, a portable tank and vaporizer may be used. Also any other manner of obtaining gas suitable for use that is known to one skilled in the art may be used.

Extrusion presses operate in cycles, with a cycle defined as one thrust of the hydraulic ram 3. Depending upon the alloy, the shape may be extruded at a rate of more than 200 feet per minute, and a continuous extrusion about as long as 300 feet may even be produced with each stroke or cycle of the press. The length of time it takes a press to go through one cycle is related to the alloy, billet size, the number of openings or holes in the die, and the shape of the extrusion. As shown in FIG. 3, the die backer 13 is formed with an alignment key 13A, which preferably has an alignment opening 13B. Alternatively or in addition, there may be an alignment key 17A in the bolster 17 which has an alignment opening 17B which assists in keeping the bolster aligned with the backer. Further there may be at least one an alignment key 5A in the die 5 with an alignment opening 5B to keep the die and the backer aligned.

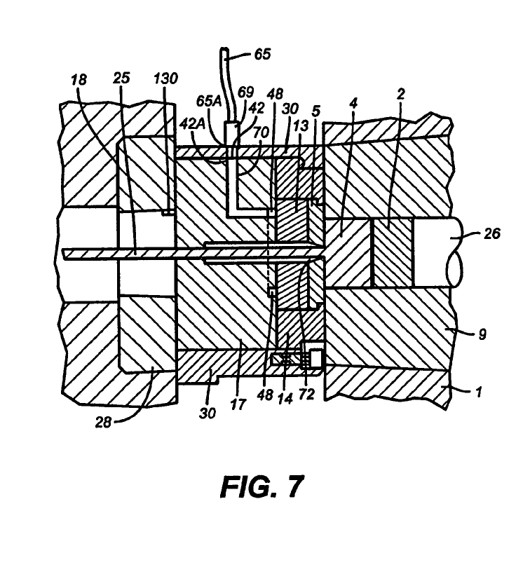

Before and during the extrusion process, the nitrogen or other inerting media is injected until the atmosphere is depleted of oxygen. There may be a single injection or introduction point or port depending upon the type of metal used, size of die, and speed of operation. The free end of a supply line e.g. 92, 94 in FIG. 4 attaches to a gas container or bulk supply, e.g., 90 and is further connected to the extruder and/or the involved conduit e.g. 70, of the backer 13. See e.g. FIGS. 3 and 7. Additionally, the supply line may be attached to the bolster 17 and/or die 5, and/or die slide 30 (not shown). Preferably, the supply line 65 for the gas or inerting media is made of stainless steel that is flexible, but could also be made of suitable non-corrosive material that is sufficiently durable. See e.g. FIG. 7. The supply line is preferably about ½ inch to 1 inch in diameter or of another diameter that provides a sufficient gas flow and is connected to the inlet 42A, typically by fittings or other such means that allow removable connection of lines.

Preferably, at least one port, and preferably only one port is machined in the selected portion of the extruder components such as a bolster 17, backer 13, die 5, die ring 14 or any other suitable location within the extruder in which to introduce the nitrogen or other inerting media. See e.g. FIGS. 3 and 7. As shown in the embodiments of FIGS. 3, and 5-7, a port 42 is machined into the bolster 17 and has an inlet end 42A and an outlet end 42B, a conduit 70 between the inlet and outlet, with the outlet end 42B joined to a junction 45 that further communicates with a header 48. The header 48 preferably has at least one, and more preferably a plurality of subports 49 that finally lead the inerting gas and/or biphasic media to an opening 75 in the bolster 17, backer 13, die 5, die ring 14, or other component. The subports 49 enable a more uniform and intense distribution of the inerting gas or media in the area 72 near or around the die exit, which is a critical area to be inerted. See e.g. FIG. 1. The backer and/or die and/or die ring may also be similarly configured with an inlet end and an outlet end joined by a junction which further communicates with a header (not shown).

Again the header of the backer and/or die and/or die ring also preferably has at least one, and more preferably plurality of subports that finally lead the inerting gas to an opening in the backer and/or die and/or die ring (not shown). The incoming gas or inerting media is preferably fed into the bolster and/or backer and/or die and/or die ring through a conduit 70, that may also be machined into the die slide 30. See e.g., FIG. 7. Preferably the free end of a supply line e.g. 65 in e.g., FIG. 7 attaches to a gas container or bulk supply and is further connected at the incoming end 65A to the extruder and/or other involved conduit 70, e.g. of the die slide 30, see e.g. FIG. 7, or may be connected to the die, die ring, backer, bolster, or other part of component of the press. Also, there is preferably a quick connector 69 which releasably connects the supply line 65 to the conduit 70. See FIG. 7.

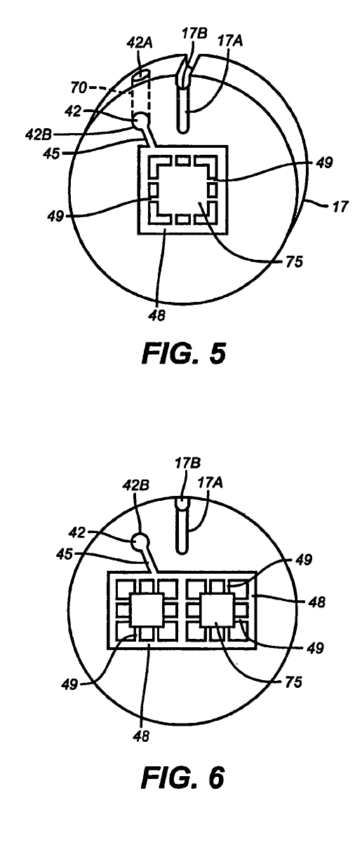

Alternatively to avoid special machining a line can be run directly into the platen or tunnel with at least one exiting port or, a wand or halo type ring with at least one opening, and alternatively a plurality of openings, may be further placed near the exit and connected to the line (not shown). There is also preferably a plurality of subports 49 (see e.g. FIGS. 5-6) that connect to the ports 42 for introducing inert or partially inert gas and/or bi-phasic inerting media.

Preferably at least one entry point or inlet e.g., 42A for the gas or inerting media is machined in the backer, bolster, die, pressure ring, or other suitable component of the extruder. Of course the entry or injection point may be placed or machined in other parts or components of the extruder. The port or ports are also preferably machined in at an angle, preferably of about 10 to 45 degrees, but may also be of another angle, such as 90 degrees. In any case, the entry point of the gas or inerting media should be near the die exit, since it is more difficult to achieve the desired environment or atmosphere if the entry points is moved away from the die exit.

Also there is preferably an analyzing means at or near the exit. The analyzing means preferably includes at least one probe or sensor 130 near the exit, which samples the nitrogen, oxygen, argon and/or other component content in the immediate environment or exit area. However, other analyzing components may be located away from the die or die exit. The sampling probe or sensor 130 is preferably run on the inside of the platen or tunnel or otherwise place near the exit. Of course an aperture for the sampling probe or sensor could also be machined into a component of the extruder. Similarly, a sample line could be placed near the die exit and the sample transferred away from the die to a sampling probe or sensor. The analyzing means may also incorporate or include a variety of other components or parts known or used by one skilled in the art, such as sample conditioning. The analyzing means further typically comprises a computer and/or other equipment or components that provide real time atmosphere analysis by continued sampling, to preferably maintain an atmosphere or environment of less than one percent oxygen.

At least one probe 130 is placed near the die exit, e.g. FIG. 7, preferably within about 1-10 cm from the die exit and periodically or continually measures the atmosphere to ensure the oxygen level stays below at least 3%, but preferably about 1% or less. Similarly, a sample line could be placed near the die exit and the sample transferred away from the die to a sampling probe or sensor. Additionally, a plurality of probes or sensors may be used to sample and detect different values or parameters at different locations in the environment.

Preferably the process and apparatus also include the use of an analyzer which monitors, oxygen levels in the gas-supplied environment at or near the exit. A preferred analyzer is the ALNAT SAMPLER™ analyzer commercially available from Air Liquide, but a Siemens Infrared or other such comparable analyzer that is commercially available or know to one skilled in the art can be used.

The apparatus may also have a plurality of ports for introducing gas and/or bi-phasic inerting media at or near the exit or away from the exit area if a more extensive inerting environment is desired or to increase the flow of gas or inerting media at or near the exit and/or platen tunnel 58.

The invention may also be further directed to the use of oxygen atmosphere sampling coupled with flow control to maintain or reduce the oxygen levels below one percent, and to optimize gas usage and effectiveness. Additionally, there is also preferably controlling means for regulating the flow rate and/or pressure of the gas and/or bi-phasic inerting media, which may be manual or automatic. The controlling means preferably comprises at least one valve or other means such as a manifold, or other components which open and close and which are known to one skilled in the art that control the pressure, flow, and/or purity of the gas or inerting media. The valves or other means may also have the ability to adjustably open and close to increase the flow of gas or inerting media or to close altogether when the inerting atmosphere is not needed. The controlling means also preferably incorporates a computer that is preferably programmed for controlling the pressure, flow, and/or purity of the gas or inerting media. In the preferred embodiment, the controlling means maintains the environment in a desired range of oxygen concentration and/or nitrogen, or argon concentration, expressed in parts per million (ppm), parts per billion (ppb), or even parts per trillion (ppt), or volume percentage or other comparable values known or used by one skilled in the art.

Optimally, the analyzing means and controlling means are coupled. The measured oxygen content may also be used by the controller or controlling means to regulate the pressure and/or flow of the gas and/or bi-phasic inerting media in a feedback loop fashion that ensures the optimized consumption of gas and/or inerting media and accommodates upsets in air flow around the extruder for purging the environment of excess oxygen. Further, the analyzer and controller may interface to maintain the environment in a desired range, and enables the apparatus to regulate the flow rate and/or pressure and/or purity of the gas or inerting media in a desired range based upon the analysis, which is preferably continuous or nearly continuous.

The apparatus also preferably has at least one component such as a computer, programmable logic device or other component known or used by one skilled in the art for recording and/or storing data about the pressure, flow, and/or purity of the gas or inerting media as well as the environment which is analyzed during the extrusion process. The data logging and reporting maybe accomplished by a Datal III™ , commercially available through Air Liquide, or other such commercially available component which is known to one skilled in the art.

The typically extruded materials from the apparatus and in the process comprise metal or alloys of metal, but may also include other types of materials and with other applications where materials readily oxidize during processing.

The apparatus also preferably has at least one unit for displaying or reporting data. The data may be displayed on a variety of components such as a CRT, LED screen, computer monitor, paper printout and other types of displaying means known or used by one skilled in the art. The apparatus may also have sound and/or light components and alarms to indicate when certain processes occur, when the desired environment is reached, or when there is a problem or failure with the inerting gas, media or environment.

The apparatus may also have platen or tunnel 58 with an end extending outward from the exit. The exit area and tunnel is where the oxidation typically takes place during extrusion. Due to the design of the apparatus, the tunnel does not have to be closed or under any certain pressures since it is about 2 to 3 feet long and the materials or pieces are inerted in the tunnel. In fact, the platen tunnel end may even be open since the gas flow at or near the die exit causes an exiting gas flow from the tunnel, thereby preventing atmospheric air from entering the tunnel or otherwise reaching the exit or exit area. Alternatively, the platen tunnel end may be partially closed. Also in an embodiment, there may also be a collar or rim (not shown) placed within the platen tunnel to partially contain the inerting gas.

The invention also contemplates a method of decreasing or inhibiting oxide formation on the surface of extruded metal or metal alloy which comprises the steps of extruding metals, metal alloys, or other materials through a die having an exit, inerting the surface of the metal or other material in the environment at or near the exit with inert or partially inert gas and/or bi-phasic inerting media, and analyzing the environment. The method may be used for metal or metal alloy comprising aluminum, zinc, and/or magnesium, or other materials which tend to oxidize during production. In this method, there are at least one, but may be a plurality of ports and/or subports for injecting gas and other inerting media at or near the exit.

FIG. 4 shows an embodiment of the invention showing a gas source 90 which is split into two separate lines, a first line 92 and a second line 94 and leads to a first extruder 102 and a second extruder 104. Of course additional extruders can be operated from a single or multiple gas or inerting media source. Prior to reaching the respective extruders, there is a first and second isolation valve 93, 95 respectively, for the first extruder and second extruder, respectively, as well as a first and second extruder control valve 97, and 98. The lines then lead to the extruders where they are introduced into the die exit area. In or around the die exit areas of the first extruder 102 and a second extruder 104, there is a first and second solenoid valve, one near each extruder, and a first 107 and a second 109 sample isolation valve. Each sample from each respective extruder is then analyzed by a single portable analyzer. The use of a single analyzer for multiple extruders will give analytical information, which can be used to manually or automatically control the gas or inerting media, but will not likely give real time data. Of course, a built in analyzer could also be used in other embodiments and/or a single analyzer could be used for each operating extruder to give real time data.

In this method, the oxygen content of the environment is analyzed. The nitrogen and/or argon content of the environment may also be analyzed, as well as any other inerting compounds or elements. The method may also comprise the step of controlling the flow rate and/or pressure of the gas and/or inerting media based upon the analysis of the environment. The method may also comprise the step of controlling the purity of the gas or inerting media based upon the analysis. Optimally, the analyzing means and controlling means are coupled. The loop analysis and control option uses sensors or probes to measure the oxygen content in the atmosphere at or near the exit, and then uses the results to regulate the flow, pressure, and/or purity of the gas or inerting media.

In practicing this method, the oxygen and/or nitrogen and/or argon concentration near or at the exit may be continually monitored, or periodically monitored at set, random, or predetermined intervals.

In this method due to cost, the inerting media or gas preferably comprises primarily nitrogen. During this method, the gas or inerting media preferably contains about 3% oxygen or less, more preferably about 1% -2%, and optimally about 0.1%-1% by volume of oxygen or less during aluminum extrusion applications. Since in the preferred embodiment the platen or tunnel is open or at least partially closed, there is preferably a continuous flow of gas and/or inerting media during extrusion. However, in some application, a near continuous flow of gas during extrusion may also suffice. Preferably, the gas flow that is controlled to maintain the desired range at or near the exit. The nitrogen flow is about 500 to 2500 standard cubic feet per hour (SCFH) but preferably about 2000-2500 SCFH, depending on the size of the press with pressures at about 50-150 psi (pounds per square inch). The temperature of the gas is not critical since the gas is not used to cool but is rather used to provide an inert or nearly inert atmosphere, and the preferred temperature parameters of the inerting gas are from about 0EC to room temperature or about 20EC. In this method, the various parameters may be controlled manually and/or automatically.

The method may also further comprise the step of placing a collar or shroud around the die exit area and at least one port may be positioned near the collar or shroud, to somewhat slow the exit of gas from the environment around the die exit area.

In this method, a platen or tunnel may be placed near or at the die exit. The platen also has an end, and the end can be open during extrusion operations, since the method can operate at ambient pressure. In another embodiment, the platen tunnel end is at least partially closed. In addition to having at least one port for introducing or adding gas or inerting media near or at the die exit, the method may further comprise adding at least one additional port and/or subport for injecting gas and/or inerting media into the platen tunnel, outward from the port used near or at the die exit. See FIGS. 5-6. Similarly, the method may also further comprise the step of placing a collar or shroud around the tunnel to somewhat slow the exit of gas from the tunnel area.

If a bi-phasic or liquid inerting media is used, it may be advantageous to place a channel around the exit so that the vaporized liquid travels around the channel and around the extruded material.

The method may further comprise the step of providing at least one component that records and/or stores data. The component can comprise a mainframe computer, hard drive, portable computer unit or other component known or used by one skilled in the art for recording and/or storing data. The data recorded or stored in this method may comprise a multitude of variables such as the pressure, flow, and/or purity of the gas or inerting media used as well as the temperature, pressure, and the purity of the inerting gas or media in the environment which is analyzed during the extrusion process. The method may also comprise tracking the volume or amount of gas or inerting media used.

The method may further comprise the step of providing at least one unit for displaying or reporting data. The unit to display such data may comprise a variety of components such as CRT, LED screen, computer monitor, paper printout and other types of displaying means known or used by one skilled in the art. The method may further comprise the step of providing sound and/or light components and alarms to indicate when certain processes occur, when the desired environment is reached, or when there is a problem or failure with the inerting gas, media or environment.

The following is an example of data that shows some of the advantages of this invention:

TABLE 1

| | Gas | | | | |
|---|---|---|---|---|---|
| | Consumption | | Die | | Die |
| | (SCFH | Extrusion | Run | Surface | Condition |
| Product | equivalent) | Speeds | Life | Quality | After Run |
| Architectural | 500-1000 | 30% faster | +60 | 50% Less | No |
| Aluminum | | | Billets | Buffing | Polishing |
| (6063) | | | | | Required |
| Structural | 600-800 | 25% faster | +75 | Bright-No | No |
| Aluminum | | | Billets | Die Lines | Polishing |
| (6061) | | | | | Required |

There are some key cost advantages of inerting the environment with the gas versus liquid based cooling. For example, the preferred embodiment comprises a delivery system which is preferably simplified in that there are few or no moving parts, and does not require recirculators for operation.

The apparatus and method are also cost efficient as no special machining of the dies or reworking of the die tooling is required. In the prior art applications, a channel must be machined into the die, and the liquid nitrogen was channeled into the backer and then the backer has another groove that feeds the gas into it. So, each die has to be machined with a channel. Now preferably, only the bolster and/or backer and/or die ring 14 requires modification. Alternatively as previously set forth, a line can be run into the platen, serving as a single port, or a wand or halo may be attached to the line, which provides multiple subports.

The prior art was also concerned with the size of the feed based on how much cooling that was needed around the die. It was assumed that anything that came out was going to inert the die exit, but what the atmosphere looked like as far as oxygen composition was ignored. The inerting was a secondary benefit, and the real focus was cooling the die. Thus, the flow rate, pressure, and/or purity of the gas or inerting media, can be monitored to maintain and/or control the desired oxygen level or ranges. The invention modifies and improves upon the prior art use of nitrogen-based die “cooling” technologies by strategically incorporating the proper gas composition and purity, phase properties, and analytical methods into the die inerting process. This invention may also in some cases lower nitrogen consumption than the previous “cooling” based methods, while greatly enhancing the inerting abilities of the gas and/or liquid.

It is to be understood that the invention may assume various alternative structures and processes and still be within the scope and meaning of this disclosure. Further, it is to be understood that any specific dimensions and/or physical characteristics related to the embodiments disclosed herein are capable of modification and alteration while still remaining within the scope of the present invention and are, therefore, not intended to be limiting. It will be understood that many additional changes in the details, materials, steps and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

1. An apparatus for inhibiting or decreasing the formation of oxides on the surface of extruded materials, comprising:
a die for extruding materials, said die having an exit;
at least one port in at least a portion of said apparatus for introducing inert or partially inert gas and/or biphasic inerting media near or at said exit;
analyzing means; and
controlling means for regulating the flow rate and/or pressure of said gas and/or biphasic inerting media.

2. The apparatus of claim 1, further comprising: a supply of inert or partially inert gas and/or biphasic inerting media.

3. The apparatus of claim 2, wherein said analyzing means and controlling means are coupled.

4. The apparatus of claim 1, wherein said controlling means comprises at least one valve.

5. The apparatus of claim 4, wherein said controlling means further comprises a computer.

6. The apparatus of claim 1, wherein said analyzing means comprises at least one sampling probe.

7. The apparatus of claim 6, wherein said analyzing means further comprises a computer and/or other equipment that provides a real time atmosphere analysis by continued sampling.

8. The apparatus of claim 1, wherein said analyzing means provides analysis of an environment at or near said exit.

9. The apparatus of claim 2, wherein said controlling means maintains said environment in a desired range.

10. The apparatus of claim 1, further comprising a platen tunnel with an end extending outward from said exit that is open or at least partially closed.

11. The apparatus of claim 1, wherein said at least one port is machined into a bolster and/or a backer, said port further comprising an inlet side and an outlet side with a junction that leads to a header.

12. The apparatus of claim 1, having a portable or permanent analyzer that analyzes samples from at least one die and which allows for automated or manual control of an environment at or near said exit.

13. The apparatus of claim 11, having a plurality of subports that lead said gas and/or biphasic inerting media from the header into an opening in the bolster or backer.

14. The apparatus of claim 8, wherein the measured oxygen content determines the pressure and/or flow of said gas and/or biphasic inerting media regulated by said controlling means.

15. The apparatus of claim 8, wherein the measured oxygen content further determines the purity of said gas regulated by said controlling means.

16. The apparatus of claim 1, wherein said at least one port is machined into said die and/or a die slide, said at least one port further having a plurality of subports that lead said gas and/or bi-phasic inerting media from a header into an opening in the die or die slide.

17. An apparatus for decreasing or eliminating oxide formation on the surface of extruded materials, comprising:
a bolster and/or backer;
a die for extruding materials, said die having an exit;
an environment near or at said exit;
at least one port in at least a portion of said apparatus for introducing inert or partially inert gas into said environment; and
at least probe for sampling said environment.

18. The apparatus of claim 17, further comprising a supply of inert or partially inert gas.

19. The apparatus of claim 17, further comprising a platen tunnel extending from said exit.

20. The apparatus of claim 19, wherein said platen tunnel end is open or is at least partially closed.

21. The apparatus of claim 17, further comprising at least one valve which can adjustably open and close said at least one port.

22. The apparatus of claim 17, further comprising an analyzer for analysis of said environment.

23. The apparatus of claim 22, further comprising a controller for regulating the flow rate and/or pressure of said gas in a desired range based upon said analysis.

24. The apparatus of claim 23, wherein said analyzer and said controller interface to maintain said environment in a desired range.

25. The apparatus of claim 22, wherein said controller is also programmable and/or regulates the purity of said gas.

26. The apparatus of claim 17, having at least one port with an inlet side and an outlet side with a junction that leads to a header.

27. The apparatus of claim 26, having a portable or permanent analyzer that analyzes samples from at least one die which allows for automated or manual control or an environment at or near said exit.

28. The apparatus of claim 17, wherein said apparatus further comprises at least one component for recording and/or storing data.

29. The apparatus of claim 28, wherein said apparatus further comprises at least one unit for displaying or reporting data.

30. The apparatus of claim 26, having a plurality of subports that lead from said header to an opening in at least a portion of a component through which said metal is extruded, wherein said component is selected from a die, a die ring, a bolster, a backer, and a combination thereof.

31. A method of decreasing or inhibiting oxide formation on the surface of extruded metal or metal alloy comprising the steps of:
extruding metals or metal alloys through a die having an exit;
inerting the surface of said metal in the environment at or near said exit with inert or partially inert gas and/or biphasic inerting media; and
analyzing said environment.

32. The method of claim 31, wherein the oxygen content of said environment is analyzed.

33. The method of claim 31, wherein the nitrogen content of said environment is analyzed.

34. The method of claim 31, further comprising the step of controlling the flow rate and/or pressure of said inerting media based upon the analysis of said environment.

35. The method of claim 31, wherein said inerting media comprises primarily nitrogen gas.

36. The method of claim 35, further comprising the step of controlling the purity of said gas based upon said analysis.

37. The method of claim 31, further comprising the step of providing at least one or a plurality of ports and/or subports for injecting said inerting media at or near said exit.

38. The method of claim 35, wherein said gas contains about 3% by volume or less of oxygen.

39. The method of claim 35, wherein said gas contains about 0.1% to about 1% by volume or less of oxygen.

40. The method of claim 31, further comprising the step of placing a platen tunnel with an end near or at said exit and leaving said end open or at least partially closed.

41. The method of claim 37, further comprising the steps of:
providing a junction that leads from said port to a header; and providing a plurality of subports that lead from said header to an opening in at least a component through which metal is extruded, wherein said component is selected from a die, a die ring, a bolster, a backer, and a combination thereof.

42. The method of claim 31, wherein said metal or metal alloy comprises aluminum, zinc, and/or magnesium.

43. The method of claim 31, further comprising the step of placing a collar around said exit and wherein said at least one port is positioned near said collar.

44. The method of claim 31, further comprising the step of placing a channel around said exit.

45. A method of reducing or eliminating the surface oxidation of extruded metal, comprising:
extruding metal through an apparatus having at least one exit;
introducing inert or partially inert gas at or near said exit;
monitoring the oxygen concentration at or near said exit; and
controlling the flow rate and/or purity of said gas based upon said analysis.

46. The method of claim 45, operated at ambient pressure.

47. The method of claim 45, wherein said oxygen concentration near or at said exit is continually monitored.

48. The method of claim 45, wherein said oxygen concentration near or at said exit is periodically monitored.

49. The method of claim 45, having a continuous flow of gas during extrusion.

50. The method of claim 45, having a near continuous flow of gas during extrusion.

51. The method of claim 45, having a gas flow that is controlled to maintain a desired oxygen concentration range at or near said exit.

52. The method of claim 45, wherein said inerting gas comprises primarily nitrogen.

53. The method of claim 52, wherein said gas contains about 3%- oxygen by volume or less.

54. The method of claim 52, wherein said gas contains about 0.1% to about 1% by volume or less of oxygen.

55. The method of claim 52, further comprising the step of using a portable or permanent analyzer that analyzes samples from at least one exit and which allows for automated or manual control of an environment at or near said exit.

56. The method of claim 52, further comprising the step of connecting a platen tunnel with an end from said at least one exit.

57. The method of claim 56, wherein said platen tunnel end is open or is at least partially closed.

58. The method of claim 55, wherein said at least one exit comprises multiple dies and said dies are operated simultaneously and share a source of gas or inerting media and/or said portable or permanent analyzer.

59. The method of claim 56, further comprising at least one port for adding gas into the platen tunnel or near said exit.

60. The method of claim 59, further comprising at least one additional port for injecting gas and/or liquid into said platen tunnel.

61. The method of claim 45, further comprising the step of placing a collar around said exit.

62. The method of claim 61, further comprising the step of placing at least one port in or near said collar.

63. The method of claim 45, further comprising the step of recording and/or storing data from said monitoring and/or said controlling.

64. The method of claim 45, further comprising the step of providing at least one unit for displaying or reporting data from said monitoring and/or said controlling.

65. The method of claim 56, further comprising the step of providing equipment that provides real time atmospheric or environmental analysis by continued sampling at or near said exit and/or in said platen tunnel.

66. The method of claim 59, further comprising the steps of:
providing a junction that leads from said port to a header; and
providing a plurality of subports that lead from said header to an opening in at least a component through which metal is extruded.

67. The method of claim 66, wherein said component is selected from the group comprising a bolster; a backer; a die; a die ring; and a combination thereof.

68. The method of claim 59 further comprising the steps of:
providing a conduit in a die slide; and
connecting a supply of gas or bi-phasic inerting media to said conduit.
